(19) United States
(12) Patent Application Publication
(10) Pub. No.: US 2024/0340085 A1
(43) Pub. Date: Oct. 10, 2024

(54) OPTICAL MODULE

(71) Applicant: FURUKAWA ELECTRIC CO., LTD., Tokyo (JP)

(72) Inventors: Kazuya NAGASHIMA, Tokyo (JP); Masaki KOTOKU, Tokyo (JP); Tatsuro KUROBE, Tokyo (JP); Kazuaki KIYOTA, Tokyo (JP); Maiko ARIGA, Tokyo (JP); Atsushi IZAWA, Tokyo (JP); Yozo ISHIKAWA, Tokyo (JP)

(73) Assignee: FURUKAWA ELECTRIC CO., LTD., Tokyo (JP)

(21) Appl. No.: 18/744,779

(22) Filed: Jun. 17, 2024

Related U.S. Application Data
(63) Continuation of application No. PCT/JP2021/047739, filed on Dec. 22, 2021.

(51) Int. Cl. H04B 10/40; G02B 6/42

(52) U.S. Cl. CPC H04B 10/40; G02B 6/4246

(57) ABSTRACT

An optical module includes: a modulator containing an InP-based semiconductor material, the modulator including a modulation signal providing unit configured to modulate input light; and an optical integrated circuit optically coupled to the modulator, the optical integrated circuit integrating a plurality of waveguides and a plurality of optical elements including a silicon-based semiconductor material. The optical integrated circuit is configured to output light passed through any one of the waveguides or any one of the optical elements to the modulator, receive modulation light generated by the modulator that modulates the light, and output the modulation light passed through any one of other waveguides or any one of other optical elements.

This application is a continuation of International Application No. PCT/JP2021/047739, filed on Dec. 22, 2021, the entire contents of which are incorporated herein by reference.

### BACKGROUND

The present disclosure relates to an optical module.

As an optical module used for optical communication, a configuration in which a plurality of elements are integrated has been known (US Patent Application Laid-open No. 2019/0103938 and WO2016/166971). Moreover, an optical module has been known in which a waveguide and an optical element are integrated on a silicon substrate, using a technique referred to as silicon photonics. It is considered that the optical module may be produced in large quantities at a low cost and high accuracy using a silicon process. The optical module may include a modulator as an optical element.

### SUMMARY

In optical communications, there is a demand for further increasing the speed. However, in silicon photonics modulators, an increase in speed may be limited due to the limited modulation speed. In contrast, for example, a modulator using an InP-based semiconductor material is considered to be able to achieve modulation speed exceeding 96 Gbd. However, in a case of combination with silicon photonics, optical loss due to optical misalignment may occur, by differences in the constituent materials or the like.

According to one aspect of the present disclosure, there is provided an optical module including: a modulator containing an InP-based semiconductor material, the modulator including a modulation signal providing unit configured to modulate input light; and an optical integrated circuit optically coupled to the modulator, the optical integrated circuit integrating a plurality of waveguides and a plurality of optical elements including a silicon-based semiconductor material, wherein the optical integrated circuit is configured to output light passed through any one of the waveguides or any one of the optical elements to the modulator, receive modulation light generated by the modulator that modulates the light, and output the modulation light passed through any one of other waveguides or any one of other optical elements.

### BRIEF DESCRIPTION OF THE DRAWINGS

FIG. 1 is a schematic diagram illustrating a configuration of an optical module according to a first embodiment;

FIG. 2 is a schematic diagram illustrating a configuration of an optical module according to a second embodiment;

FIG. 3 is a schematic diagram illustrating a configuration of an optical module according to a third embodiment;

FIG. 4 is a schematic diagram illustrating a configuration of an optical module according to a fourth embodiment;

FIG. 5 is a schematic diagram illustrating a configuration of an optical module according to a fifth embodiment;

FIG. 6 is a schematic diagram illustrating a configuration of an optical module according to a sixth embodiment;

FIG. 7 is a side view of part of the optical module illustrated in FIG. 6;

FIG. 8 is a schematic diagram illustrating a configuration of a silicon platform; and

FIG. 9 is a schematic diagram illustrating an installation state of the silicon platform illustrated in FIG. 8.

### DETAILED DESCRIPTION

Hereinafter, embodiments will be described with reference to the drawings. However, the disclosure is not limited to the embodiments. Moreover, in the description of the drawings, the same reference numerals denote the same or corresponding elements as appropriate. Furthermore, the drawings are schematic, and it should be noted that the dimensional relation of the elements, the ratio of the elements, and the like may differ from the actual situation. Even between the drawings, there may be a case where portions with different dimensional relations and ratios are included.

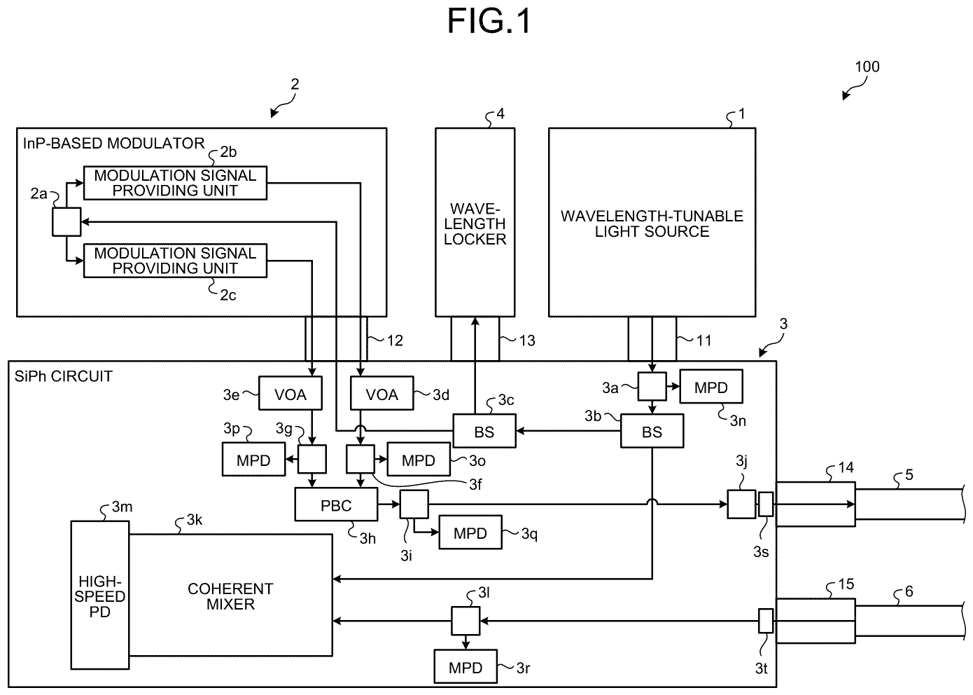

FIG. 1 is a schematic diagram illustrating a configuration of an optical module according to a first embodiment. An optical module 100 includes a wavelength-tunable light source 1, a modulator 2, an optical integrated circuit 3, a wavelength locker 4, optical fibers 5 and 6, and optical coupling elements 11, 12, 13, 14, and 15.

For example, the wavelength-tunable light source 1 includes a semiconductor laser element, and is configured to be able to change the wavelength of the output laser beam in a predetermined range within the wavelength bandwidth of 1530 nm to 1625 nm, for example. The wavelength-tunable light source 1 outputs a laser beam that is input to the optical integrated circuit 3 and is output to the modulator 2.

For example, the modulator 2 is a Mach-Zehnder (MZ) type phase modulator, which is a known phase modulator that is imparted with a modulation signal from the outside to function as an IQ modulator. The modulator 2 includes an optical branching unit 2a, modulation signal providing units 2b and 2c, and a plurality of waveguides that achieve optical connection in the modulator 2. The optical branching unit 2a branches the light input to the modulator 2 into two lights. The modulation signal providing units 2b and 2c respectively receive the two lights branched by the optical branching unit 2a, generate modulation light by modulating the input light, and output the modulation light. The two modulation lights are in a linearly polarized state that are orthogonal to each other. The modulator 2 is also referred to as an InP-based modulator, and the modulation signal providing units 2b and 2c at least include an InP-based semiconductor material.

The optical integrated circuit 3 is an optical integrated circuit in which a plurality of waveguides and a plurality of optical elements including a silicon-based semiconductor material are integrated, and is also referred to as a silicon photonics (SiPh) circuit. For example, the silicon-based semiconductor material includes a SiGe-based semiconductor material. Moreover, the optical integrated circuit 3 may include an insulating layer made of silicon oxide. The waveguides achieve optical connection in the optical integrated circuit 3. Furthermore, as optical elements, the optical integrated circuit 3 includes an optical branching element 3a, beam splitters (BSs) 3b and 3c, variable optical attenuators (VOAs) 3d and 3e, optical branching elements 3f and 3g, a polarization beam combiner (PBC) 3h, an optical branching element 3i, an optical equalizer 3j, a coherent mixer 3k, an optical branching element 3l, a high-speed photo diode (PD) 3m that is a light receiving element, monitor PDs 3n, 3o, 3p, 3q, and 3r that are light receiving elements, and optical filters 3s and 3t. The functions of these optical elements will be described in detail below.

The wavelength locker 4 is an example of a wavelength detector that detects the wavelength of light output from the wavelength-tunable light source 1. For example, the wavelength locker 4 is a known product that includes a planar lightwave circuit (PLC) and a PD array. The PLC branches the input light into three lights, and outputs one of the three lights to the PD array. The PLC also outputs the other two lights to the PD array after allowing the two lights to respectively pass through two filters the transmission characteristics of which change in a substantially periodical manner with respect to the wavelength, and that have wavelength discrimination characteristics. For example, the two filters include a ring resonator and an MZ interferometer, and have transmission wavelength characteristics different from each other. In the PD array, three PDs are arranged in the form of an array. Each of the three PDs in the PD array receives each of the three lights output from the PLC, and outputs a current signal corresponding to the intensity of the received light. Each current signal is transmitted to an external controller through the wiring pattern, and is used to detect and control the wavelength of the light.

The optical fiber 5 is optically coupled to the optical integrated circuit 3, and outputs the light output from the optical integrated circuit 3 to the outside. The optical fiber 6 is optically coupled to the optical integrated circuit 3, and inputs the light from outside to the optical integrated circuit 3. For example, the optical fibers 5 and 6 are known single-mode optical fibers for communication.

The optical coupling element 11 optically couples the wavelength-tunable light source 1 and the optical integrated circuit 3. The optical coupling element 12 optically couples the modulator 2 and the optical integrated circuit 3. The optical coupling element 13 optically couples the wavelength locker 4 and the optical integrated circuit 3. The optical coupling element 14 optically couples the optical fiber 5 and the optical integrated circuit 3. The optical coupling element 15 optically couples the optical fiber 6 and the optical integrated circuit 3. The optical coupling elements 11 to 15 each include a lens, a gradient index (GRIN) lens, an optical fiber, a waveguide, or a photonic wire. The photonic wire is a wire made of resin or the like, and that guides light. The lens is made of a single lens or a combination of single lenses. The lens, the GRIN lens, and the waveguide may be arranged in the form of an array, and may be configured as an array element.

Next, an example of the functions of the optical module 100 will be described. In FIG. 1, optical paths of light in the optical module 100 are illustrated with arrows. The waveguides included in the wavelength-tunable light source 1, the modulator 2, and the optical integrated circuit 3 are configured to guide the lights within an allowable range of optical loss. For example, the bending radius is designed to be equal to or less than an allowable bending loss.

The wavelength-tunable light source 1 outputs a linearly polarized laser beam. The optical coupling element 11 couples the laser beam from the wavelength-tunable light source 1 to the waveguide of the optical integrated circuit 3.

In the optical integrated circuit 3, the optical branching element 3a allows most of the laser beam guided through the waveguide of the optical integrated circuit 3 to pass therethrough, and outputs the laser beam to the beam splitter 3b. Also, the optical branching element 3a branches a part of the laser beam, and outputs the branched laser beam to the monitor PD 3n. The monitor PD 3n outputs a current signal corresponding to the intensity of the received light. The current signal is transmitted to an external controller through the wiring pattern, and is used to monitor the output of the wavelength-tunable light source 1.

The beam splitter 3b allows most of the laser beam from the optical branching element 3a to pass therethrough, and outputs the laser beam to the beam splitter 3c via a waveguide. Also, the beam splitter 3b branches a part of the laser beam, and outputs the branched laser beam to the coherent mixer 3k via a waveguide.

The beam splitter 3c allows most of the laser beam from the beam splitter 3b to pass therethrough, and outputs the laser beam to the optical coupling element 12 via a waveguide. Also, the beam splitter 3c branches a part of the laser beam, and outputs the branched laser beam to the wavelength locker 4 via a waveguide.

The optical coupling element 12 couples the laser beam from the beam splitter 3c to the waveguide of the modulator 2.

In the modulator 2, the optical branching unit 2a branches the laser beam from the optical coupling element 12 into two laser beams. The modulation signal providing units 2b and 2c each receive one of the two laser beams branched by the optical branching unit 2a, perform IQ-modulation on each of the input laser beams, generate modulation light in a linearly polarized state that are orthogonal to each other, and output the generated modulation light to the optical coupling element 12 via a waveguide.

The optical coupling element 12 outputs the two modulation lights from the modulator 2 respectively to the variable optical attenuators 3d and 3e via a waveguide. The variable optical attenuators 3d and 3e each attenuate the input modulation light, and output the modulation light to each of the optical branching elements 3f and 3g via a waveguide. The attenuation amount of the variable optical attenuators 3d and 3e is controlled by an electrical signal transmitted from an external controller through the wiring pattern.

The optical branching elements 3f and 3g each allow most of the modulation light from the variable optical attenuators 3d and 3e to pass therethrough, and output the modulation light to the polarization beam combiner 3h via a waveguide. Also, the optical branching elements 3f and 3g branch a part of the modulation light, and output the branched modulation light to each of the monitor PDs 3o and 3p. The monitor PDs 3o and 3p output a current signal corresponding to the intensity of the received light. The current signal is transmitted to an external controller through the wiring pattern, and is used to monitor the output of the variable optical attenuators 3d and 3e and to control the attenuation amount.

The polarization beam combiner 3h polarizes and combines the modulation light from the optical branching elements 3f and 3g, and outputs the modulation light to the optical branching element 3via a waveguide.

The optical branching element 3allows most of the modulation light from the polarization beam combiner 3h to pass therethrough, and outputs the modulation light to the optical equalizer 3j via a waveguide. Also, the optical branching element 3i branches a part of the modulation light, and outputs the branched modulation light to the monitor PD 3q. The monitor PD 3q outputs a current signal corresponding to the intensity of the received light. The current signal is transmitted to an external controller through the wiring pattern, and is used to monitor the output of the polarization beam combiner 3h.

The optical equalizer 3j outputs the modulation light from the optical branching element 3i to the optical coupling element 14 via the optical filter 3s, by applying attenuation of predetermined spectral characteristics so that the modulation light becomes a desired shape such as spectrally flat. The optical equalizer 3j may be easily formed on a waveguide by a lattice-type optical circuit or the like. For example, the optical equalizer 3j is disclosed in Tu2.D.2 and Tu3.B.1 of ECOC 2019, Dublin, Ireland that are non-patent literature. Moreover, the optical equalizer 3j may be a known one configured including a liquid crystal on silicon (LCOS) and a diffraction grating. However, by forming the optical equalizer 3j on a waveguide as in the present configuration, it is highly effective in implementing an optical module that is economical and small in size.

The optical coupling element 14 couples the modulation light that has transmitted through the optical filter 3s to the optical fiber 5. The optical fiber 5 propagates the modulation light to the outside.

By contrast, the optical fiber 6 propagates the signal light from outside, and outputs the signal light to the optical coupling element 15. The optical coupling element 15 couples the signal light from the optical fiber 6 to the waveguide of the optical integrated circuit 3 via the optical filter 3t.

In the optical integrated circuit 3, the optical branching element 31 allows most of the signal light guided through the waveguide of the optical integrated circuit 3 to pass therethrough, and outputs the signal light to the coherent mixer 3k. Also, the optical branching element 31 branches a part of the signal light, and outputs the branched signal light to the monitor PD 3r. The monitor PD 3r outputs a current signal corresponding to the intensity of the received light. The current signal is transmitted to an external controller through the wiring pattern, and is used to monitor the power of the signal light.

The coherent mixer 3k includes a 90-degree optical hybrid circuit. Also, the coherent mixer 3k processes the signal light input from the optical branching element 31 via a waveguide and the laser beam (local oscillation light) input from the beam splitter 3b via a waveguide, by causing the signal light and the laser beam to interfere with each other, generates processing signal light, and outputs the processing signal light to the high-speed PD 3m. The processing signal light includes four signal lights including Ix signal light corresponding to an I component of X polarization, Qx signal light corresponding to a Q component of X polarization, Iy signal light corresponding to an I component of Y polarization, and Qy signal light corresponding to a Q component of Y polarization.

The high-speed PD 3m includes four balanced PDs, receives each of the four processing signal lights, and converts the received processing signal light into a current signal to output. The current signal is transmitted to a controller or a higher-level control device through the wiring pattern, and is used to demodulate the signal light.

The optical filters 3s and 3t mainly transmit the light in a wavelength range in which the signal light and modulation light are included, and have characteristics of cutting the noise light with a wavelength outside the wavelength range described above. The noise light may be generated, for example, in the optical transmission line, the light source, or the like. The optical filters 3s and 3t may be easily formed by various configurations such as a lattice type, an arrayed waveguide gratings (AWG) type, and gratings (for example, Optics Express Vol. 24, Issue 26, pp. 29577-29582 (2016), which is non-patent literature).

In the optical module 100 configured as described above, the optical integrated circuit 3 serving as a SiPh circuit outputs the laser beam that has passed through the integrated waveguides and optical elements to the InP-based modulator 2; the modulator 2 generates modulation light; and the optical integrated circuit 3 receives the modulation light and outputs the modulation light that has passed through the integrated waveguides and optical elements. Therefore, by making the optical module 100 suitable for high-speed modulation using the InP-based modulator 2, and by reducing the points where light propagates in space as much as possible by the optical integrated circuit 3 serving as an SiPh circuit, and using the inner waveguide propagation, it is possible to suppress the optical misalignment during assembly or with time, and suppress the optical loss such as coupling loss. In particular, because the modulator 2 and the optical integrated circuit 3 including different material systems, are coupled at the minimum number of optical coupling points, effects in suppressing the optical loss are remarkable. Moreover, in the optical module 100, the number of components and component costs may be reduced, and whereby the cost reduction may be achieved.

In the optical module 100, a portion including the wavelength-tunable light source 1 and the modulator 2 forms a light transmission unit, and a portion including the coherent mixer 3k forms a light reception unit. The optical module 100 described above is applicable to the integrated coherent transmitter-receiver optical sub-assembly (IC-TROSA) Type-II, for example, by the Optical Internetworking Forum (OIF).

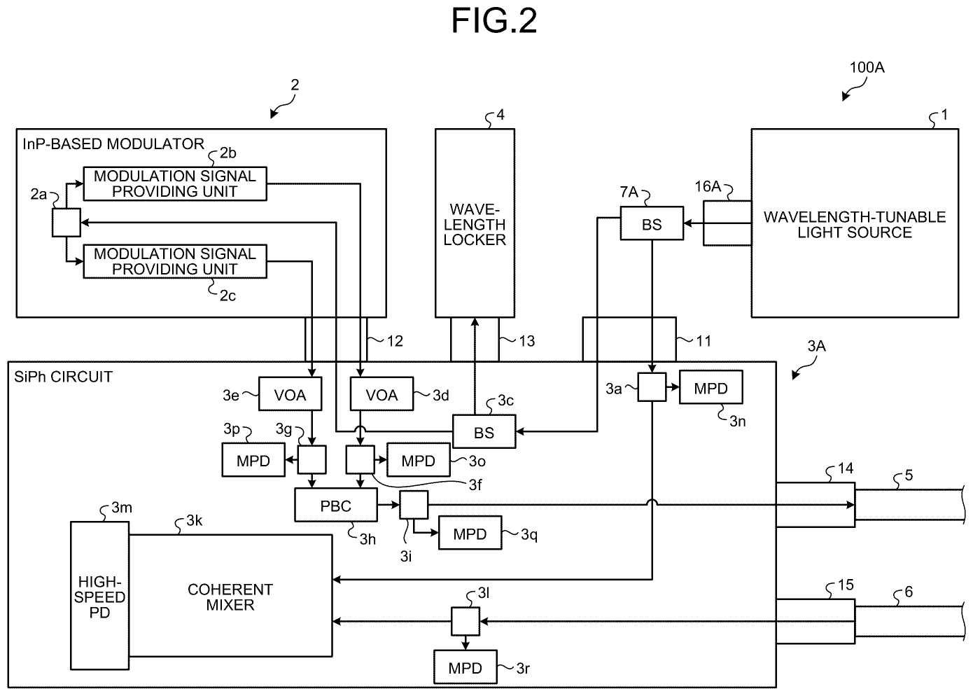

FIG. 2 is a schematic diagram illustrating a configuration of an optical module according to a second embodiment. In the configuration of the optical module 100 illustrated in FIG. 1, an optical module 100A has a configuration in which the optical integrated circuit 3 is replaced with an optical integrated circuit 3A, and a beam splitter 7A and an optical coupling element 16A are added. In the configuration of the optical integrated circuit 3, the optical integrated circuit 3A has a configuration in which the beam splitter 3b, the optical equalizer 3j, and the optical filters 3s and 3t are removed.

An example of the functions of the optical module 100A will be described.

The optical coupling element 16A couples the laser beam from the wavelength-tunable light source 1 to the beam splitter 7A by spatial coupling. The beam splitter 7A is an optical element that is not integrated, and is spatially coupled to the optical coupling element 11. The beam splitter 7A allows most of the laser beam to pass therethrough, and outputs the laser beam to the beam splitter 3c via the optical coupling element 11 and the waveguide of the optical integrated circuit 3A. Also, the beam splitter 3c branches a part of the laser beam, and outputs the branched laser beam to the optical branching element 3a via the optical coupling element 11 and the waveguide of the optical integrated circuit 3A. The optical branching element 3a allows most of the laser beam guided through the waveguide of the optical integrated circuit 3A to pass therethrough, and outputs the laser beam to the coherent mixer 3k via a waveguide. Also, the optical branching element 3a branches a part of the laser beam, and outputs the branched laser beam to the monitor PD 3n.

Other functions of the optical module 100A are similar to those of the optical module 100. Hence, the description thereof will be omitted.

In the optical module 100A configured as described above, the optical loss may also be suppressed, the number of components and component costs may be reduced, and the cost reduction may be achieved. Moreover, for example, such an optical module 100A may be applied to the IC-TROSA Type-II.

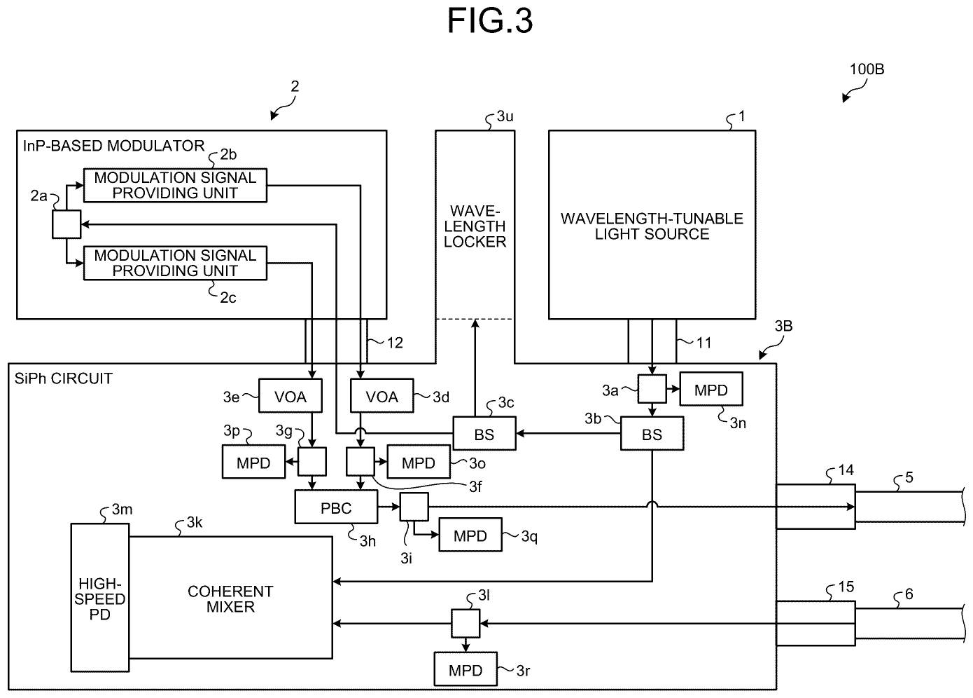

FIG. 3 is a schematic diagram illustrating a configuration of an optical module according to a third embodiment. In the configuration of the optical module 100 illustrated in FIG. 1, an optical module 100B has a configuration in which the optical integrated circuit 3 is replaced with an optical integrated circuit 3B, and the wavelength locker 4 and the optical coupling element 13 are removed.

In the configuration of the optical integrated circuit 3, the optical integrated circuit 3B has a configuration in which a wavelength locker 3u is added and the optical equalizer 3j is removed. The wavelength locker 3u has the same configuration and functions as those of the wavelength locker 4, except that the wavelength locker 3u includes a silicon-based semiconductor material and is integrated in the optical integrated circuit 3B.

An example of the functions of the optical module 100B is the same as that of the optical module 100. However, the optical module 100B is different from the optical module 100 in that the beam splitter 3c branches a part of the laser beam from the beam splitter 3b, and outputs the branched laser beam to the wavelength locker 3u via a waveguide.

In the optical module 100B configured as described above, the optical loss may also be suppressed, the number of components and component costs may be reduced, and the cost reduction may be achieved. Moreover, for example, such an optical module 100B may be applied to the IC-TROSA Type-II.

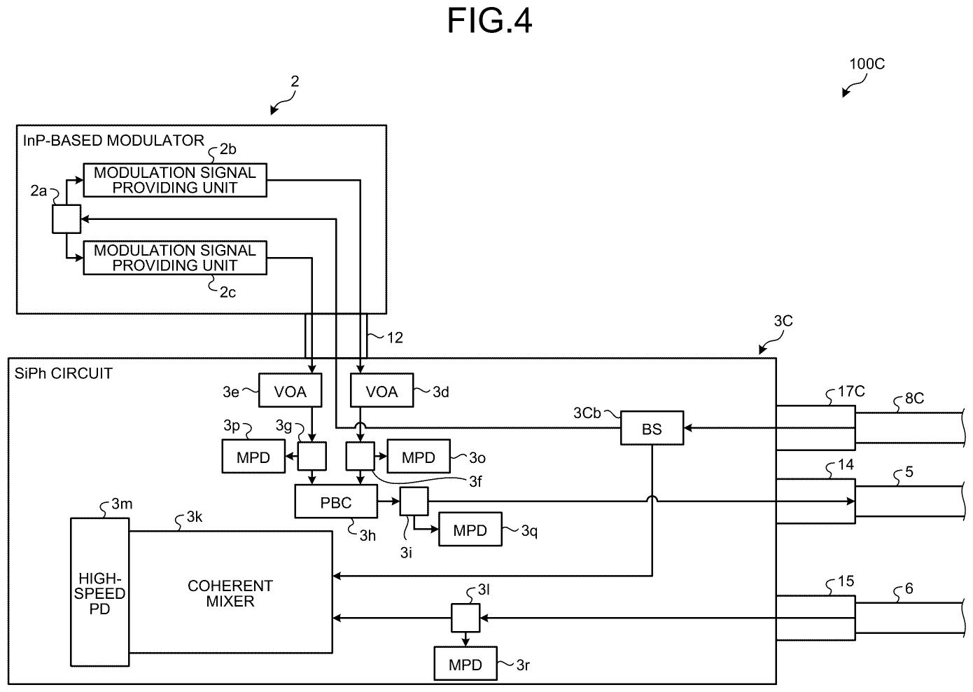

FIG. 4 is a schematic diagram illustrating a configuration of an optical module according to a fourth embodiment. In the configuration of the optical module 100 illustrated in FIG. 1, an optical module 100C has a configuration in which the optical integrated circuit 3 is replaced with an optical integrated circuit 3C, the wavelength-tunable light source 1, the wavelength locker 4, and the optical coupling elements 11 and 13 are removed, and an optical coupling element 17C and an optical fiber 8C are added.

In the configuration of the optical integrated circuit 3, the optical integrated circuit 3C has a configuration in which a beam splitter 3Cb is added, and the beam splitters 3b and 3c, the optical equalizer 3j, the monitor PD 3n, and the optical filters 3s and 3t are removed.

An example of the functions of the optical module 100C will be described.

The optical fiber 8C propagates the laser beam from outside, and outputs the laser beam to the optical coupling element 17C. The laser beam has the same characteristics as the laser beam output from the wavelength-tunable light source 1. The optical coupling element 17C couples the laser beam from the optical fiber 8C to the waveguide of the optical integrated circuit 3C.

In the optical integrated circuit 3C, the beam splitter 3Cb allows most of the laser beam guided through the waveguide of the optical integrated circuit 3C to pass therethrough, and outputs the laser beam to the optical coupling element 12. Also, the beam splitter 3Cb branches a part of the laser beam, and outputs the branched laser beam to the coherent mixer 3k.

That is, a part of the light input from the optical fiber 8C is modulated by the modulator 2 into modulation light, and a part of the light is used as local oscillation light in the coherent mixer 3k.

Other functions of the optical module 100C are similar to those of the optical module 100. Hence, the description thereof will be omitted.

In the optical module 100C configured as described above, the optical loss may also be suppressed, the number of components and component costs may be reduced, and the cost reduction may be achieved. Moreover, for example, such an optical module 100C may be applied to the IC-TROSA Type-I.

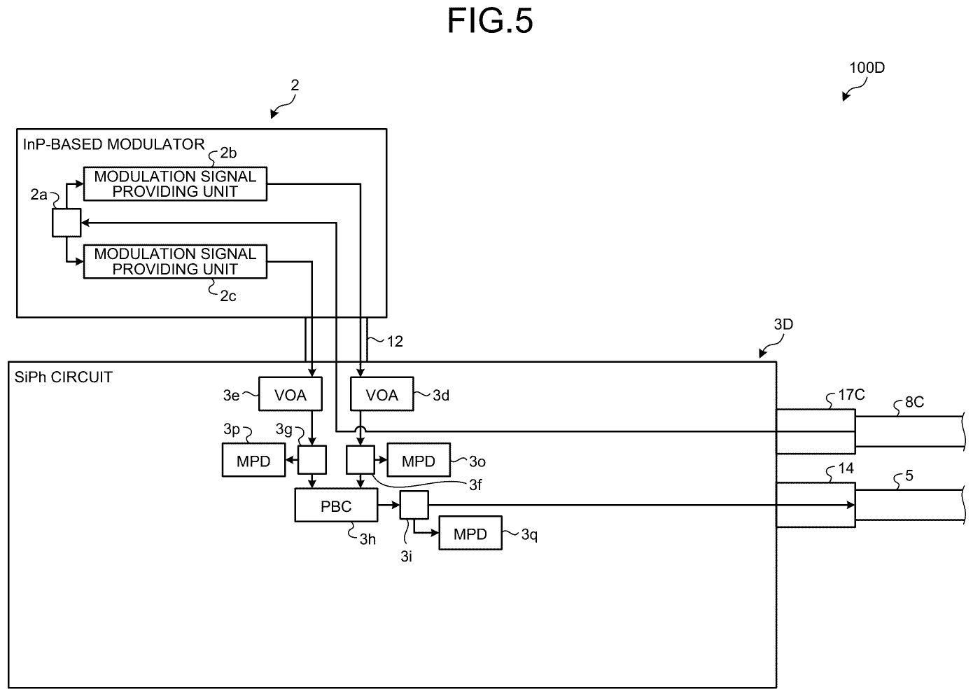

FIG. 5 is a schematic diagram illustrating a configuration of an optical module according to a fifth embodiment. In the configuration of the optical module 100C illustrated in FIG. 4, an optical module 100D has a configuration in which the optical integrated circuit 3C is replaced with an optical integrated circuit 3D, and the optical coupling element 15 and the optical fiber 6 are removed.

In the configuration of the optical integrated circuit 3C, the optical integrated circuit 3D has a configuration in which the beam splitter 3Cb, the coherent mixer 3k, the optical branching element 3l, the high-speed PD 3m, and the monitor PD 3r are removed.

An example of the functions of the optical module 100D will be described.

The optical fiber 8C propagates the laser beam from outside, and outputs the laser beam to the optical coupling element 17C. The laser beam has the same characteristics as the laser beam output from the wavelength-tunable light source 1. The optical coupling element 17C couples the laser beam from the optical fiber 8C to the waveguide of the optical integrated circuit 3D.

In the optical integrated circuit 3D, the waveguide outputs the guided laser beam to the optical coupling element 12.

That is, the light input from the optical fiber 8C is modulated by the modulator 2 into modulation light. Moreover, the optical module 100D has no function relating to the coherent mixer.

Other functions of the optical module 100D are similar to those of the optical module 100C. Hence, the description thereof will be omitted.

In the optical module 100D configured as described above, the optical loss may also be suppressed, the number of components and component costs may be reduced, and the cost reduction may be achieved. Moreover, for example, such an optical module 100D may be applied to a high bandwidth coherent driver modulator (HB-CDM) with OIF.

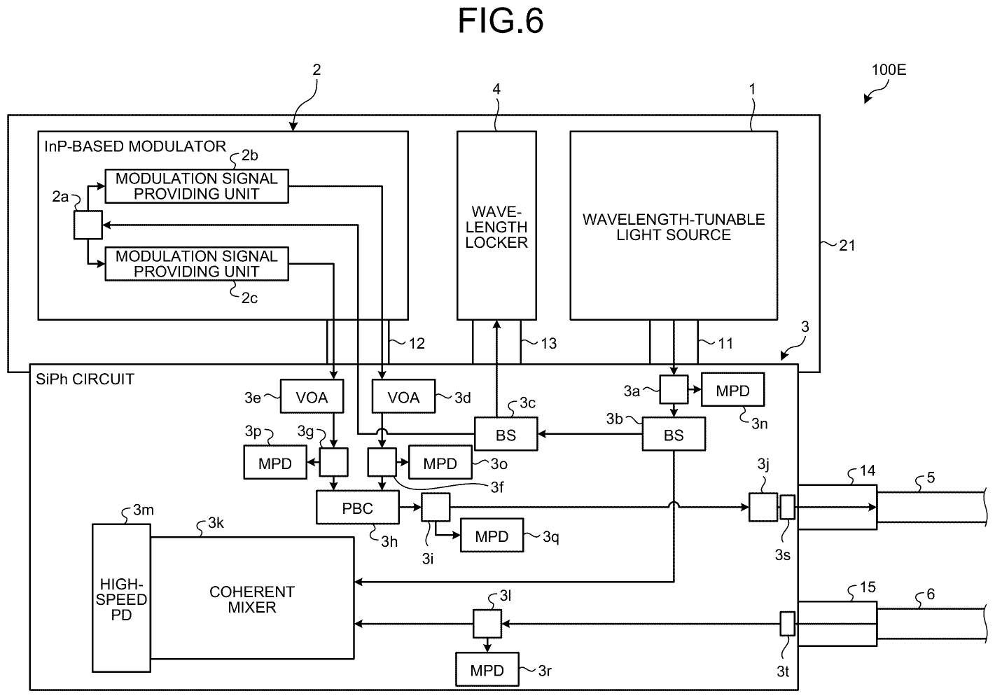

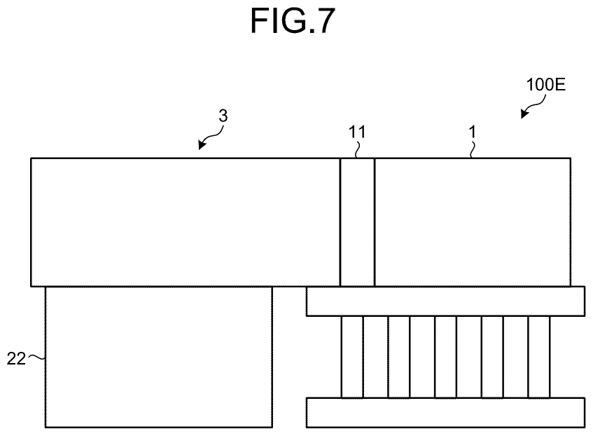

FIG. 6 is a schematic diagram illustrating a configuration of an optical module according to a sixth embodiment. FIG. 7 is a side view of part of the optical module illustrated in FIG. 6. In the configuration of the optical module 100 illustrated in FIG. 1, an optical module 100E has a configuration in which a temperature control element 21 and a spacer 22 are added.

The wavelength-tunable light source 1, the wavelength locker 4, and the modulator 2 are loaded on the temperature control element 21. Moreover, part of the optical integrated circuit 3 is loaded on the temperature control element 21. Specifically, a peripheral portion of a portion of the optical integrated circuit 3 that is optically coupled to the wavelength-tunable light source 1, the modulator 2, and the wavelength locker 4 is loaded on the temperature control element 21. The being loaded is an example of a mode where thermal contact may be achieved.

The optical integrated circuit 3 is loaded on the spacer 22. The height of the spacer 22 is adjusted so that part of the optical integrated circuit 3 may be loaded on the temperature control element 21.

The functions of the optical module 100E are similar to those of the optical module 100C. Hence, the description thereof will be omitted.

In the optical module 100E configured as described above, the optical loss may also be suppressed, the number of components and component costs may be reduced, and the cost reduction may be achieved. Moreover, in the optical module 100E, because the temperature control element 21 is in thermal contact with the modulator 2, the temperature of the modulator 2 may be maintained at a substantially constant temperature. Hence, the modulation characteristics of the modulator 2 may be stabilized. Furthermore, because the temperature control element 21 is in thermal contact with the peripheral of the portion of the optical integrated circuit 3 optically coupled to the modulator 2, the optically coupled portion is maintained at substantially the same temperature as the modulator 2. As a result, it is possible to suppress the occurrence of a situation where the optical loss is increased due to the misalignment caused by the differences between the thermal expansion coefficients of the temperature control element 21 and the optical integrated circuit 3. Moreover, because the temperature control element 21 is similarly in thermal contact with the wavelength-tunable light source 1 and the wavelength locker 4, the characteristics of the wavelength-tunable light source 1 and the wavelength locker 4 may also be stabilized. Hence, it is possible to suppress the occurrence of a situation where the optical loss is increased.

A portion of the optical integrated circuit 3 in thermal contact with the temperature control element 21 includes the end surface of each waveguide of the optical integrated circuit 3 optically coupled to each of the optically coupled element 11 that is optically coupled to the wavelength-tunable light source 1, the optical coupling element 12 that is optically coupled to the modulator 2, and the optical coupling element 13 that is optically coupled to the wavelength locker 4. Moreover, the size of the portion of the optical integrated circuit 3 in thermal contact with the temperature control element 21 is suitably set according to the allowable misalignment or the like. However, for example, the portion is a region of about 0.5 mm away from the end surface optically coupled to the optical coupling elements 11, 12, and 13. Furthermore, if the entire optical integrated circuit 3 is in thermal contact with the temperature control element 21, the power consumption of the temperature control element 21 will be excessively large. Hence, it is preferable that an area of the surface of the optical integrated circuit 3 to be installed on the temperature control element 21 be equal to or less than 50%.

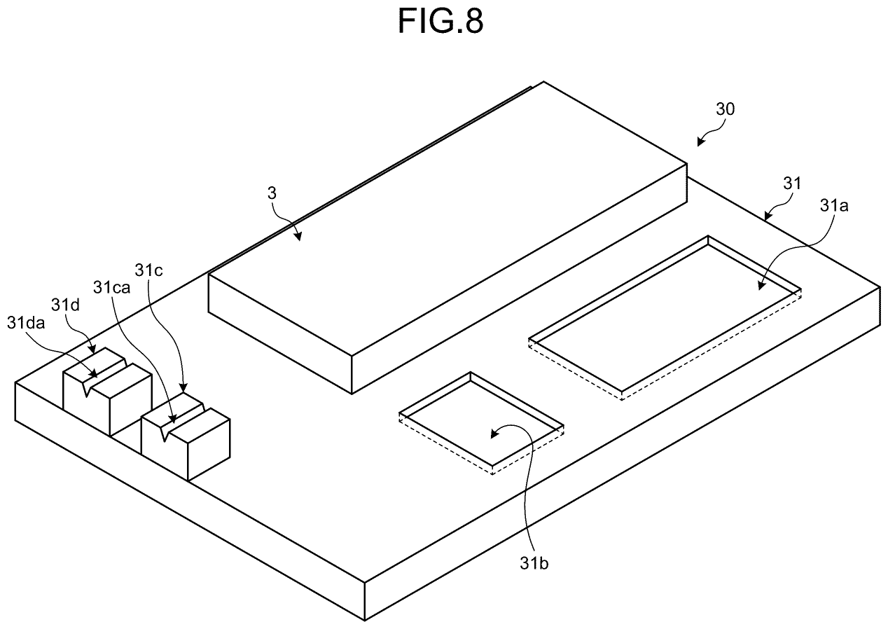

The optical integrated circuit described in the embodiments described above may be integrally configured with a base including a silicon-based semiconductor material. As an example, FIG. 8 is a schematic diagram illustrating a configuration of a silicon platform 30 including a portion where the optical integrated circuit 3 and a base 31 are integrally configured. The silicon platform 30 has a configuration in which the optical integrated circuit 3 is provided on part of the main surface of the flat base 31. Moreover, the silicon platform 30 has counterbore parts 31a and 31b, and optical fiber installation parts 31c and 31d on a part of the main surface. The optical fiber installation parts 31c and 31d protrude from the main surface of the base 31, and their respective top surfaces are provided with grooves 31ca and 31da. In the present embodiment, the grooves 31ca and 31da are V-grooves, but may be U-grooves.

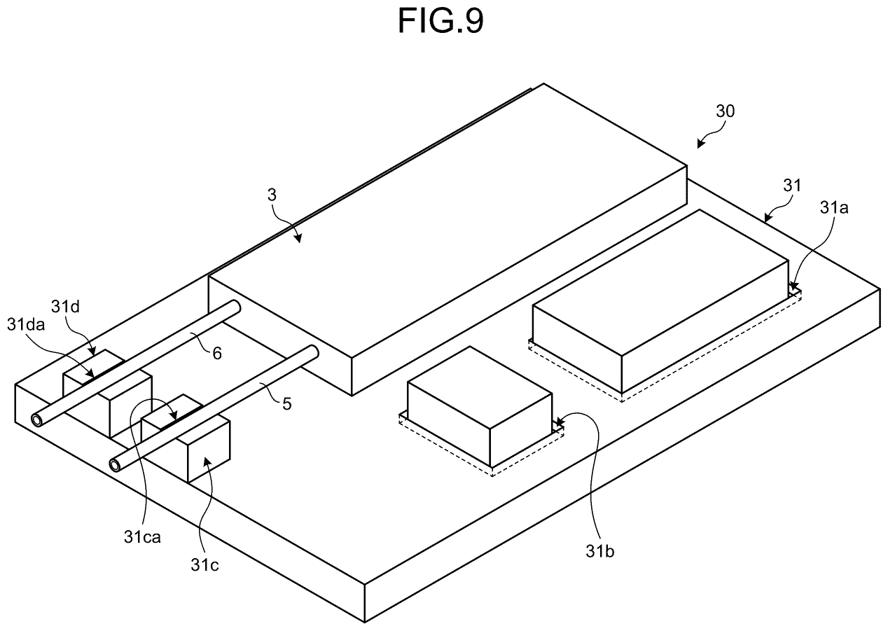

FIG. 9 is a schematic diagram illustrating an installation state of the silicon platform 30. In FIG. 9, as an example, the modulator 2 is installed in the counterbore part 31a, and the wavelength-tunable light source 1 is installed in the counterbore part 31b. The counterbore part 31a is an example of a modulator installation part, and the counterbore part 31b is an example of a wavelength-tunable light source installation part. Moreover, in the optical fiber installation part 31c, the optical fiber 5 is installed so that part of the optical fiber 5 is accommodated in the groove 31ca. In the optical fiber installation part 31d, the optical fiber 6 is installed so that part of the optical fiber 6 is accommodated in the groove 31da.

The optical integrated circuit 3, the counterbore parts 31a and 31b, and the optical fiber installation parts 31c and 31d are formed by a silicon process so that the relative positions are highly accurate. In the optical modules using such a silicon platform 30, the relative positions of the modulator 2, the optical integrated circuit 3, and the optical fibers 5 and 6 are highly accurate. Hence, the optical loss may further be suppressed.

In the embodiment described above, the wavelength-tunable light source 1, the modulator 2, and the wavelength locker 4 are optically coupled to the optical integrated circuit by the optical coupling element. However, the optical coupling may be made by butt joint. In this case, the number of the optical coupling elements to be used may be further reduced. For example, the modulator 2 and the optical integrated circuit are optically coupled, when the waveguides that output and input light are butt joined to each other.

Moreover, in the embodiment described above, the modulator 2 may include an optical amplifier that amplifies the light input to the modulation signal providing units 2b and 2c or the modulation light. For example, the optical amplifier is a semiconductor optical amplifier that includes an InP-based semiconductor material. Such a semiconductor optical amplifier may be integrated with the modulation signal providing units 2b and 2c.

In the embodiment described above, a silicon lens may be integrated in the optical integrated circuit as an optical element. Moreover, a transimpedance amplifier (TIA) that converts the current signal output from the high-speed PD 3m into a voltage signal, a digital modulator driver (DRV) that drives the modulator 2, a control IC serving as a controller, and the like may also be integrated in the optical integrated circuit or platform described above. Furthermore, an optical isolator, a DC blocking, and a terminator may be integrated in the optical integrated circuit. Still furthermore, the optical equalizer may be provided outside the optical integrated circuit.

Still furthermore, in the embodiment described above, the optical integrated circuit is configured on a single chip. However, the coherent mixer and the other portions may be configured on separate chips, and optically joined by butt joint or an optical coupling element.

According to the present disclosure, it is possible to implement an optical module that is suitable for high-speed modulation, and the optical loss of which is suppressed at a low cost.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical module comprising:
a modulator containing an InP-based semiconductor material, the modulator including a modulation signal providing unit configured to modulate input light; and
an optical integrated circuit optically coupled to the modulator, the optical integrated circuit integrating a plurality of waveguides and a plurality of optical elements including a silicon-based semiconductor material, wherein
the optical integrated circuit is configured to
output light passed through any one of the waveguides or any one of the optical elements to the modulator,
receive modulation light generated by the modulator that modulates the light, and
output the modulation light passed through any one of other waveguides or any one of other optical elements.

2. The optical module according to claim 1, wherein the optical coupling is made by butt joint or an optical coupling element.

3. The optical module according to claim 2, wherein the optical coupling element includes a lens, a GRIN lens, an optical fiber, a waveguide or a photonic wire.

4. The optical module according to claim 1, wherein the modulator includes an optical amplifier configured to amplify light input to the modulation signal providing unit or the modulation light.

5. The optical module according to claim 1, wherein the optical element includes a lens, a light receiving element, a polarization beam combiner or a variable optical attenuator.

6. The optical module according to claim 1, wherein the optical element includes:
a light receiving element; and
a light branching element configured to branch a part of passing light and output the branched light to the light receiving element.

7. The optical module according to claim 1, wherein
the modulation signal providing unit includes two modulation signal providing units,
the optical element includes a polarization beam combiner and two variable optical attenuators,
the two variable optical attenuators are configured to attenuate two respective modulation lights generated by the two modulation signal providing units, and
the polarization beam combiner is configured to polarize and combine the attenuated two modulation lights.

8. The optical module according to claim 1, wherein the optical integrated circuit includes an optical filter and an optical equalizer.

9. The optical module according to claim 1, further comprising an optical fiber optically coupled to the optical integrated circuit.

10. The optical module according to claim 1, wherein the optical integrated circuit is integrally configured with a base including a silicon-based semiconductor material, the base including a modulator installation part in which the modulator is installed.

11. The optical module according to claim 10, wherein the base includes an optical fiber installation part in which the optical fiber is installed.

12. The optical module according to claim 1, further comprising a light source configured to output light input to the optical integrated circuit and output to the modulator.

13. The optical module according to claim 12, further comprising a wavelength detector configured to detect a wavelength of light output from the light source.

14. The optical module according to claim 13, wherein the wavelength detector is integrated in the optical integrated circuit.

15. The optical module according to claim 1, wherein the optical element includes a coherent mixer.

16. The optical module according to claim 15, wherein the optical element includes a light receiving element configured to receive light output from the coherent mixer.

17. The optical module according to claim 1, further comprising a temperature control element that is in thermal contact with the modulator and a peripheral of a portion of the optical integrated circuit optically coupled to the modulator.
